(19) United States
(12) Patent Application Publication
(10) Pub. No.: US 2023/0203626 A1
(43) Pub. Date: Jun. 29, 2023

(54) MULTICOMPONENT FECOSIM SOFT MAGNETIC ALLOY AND PREPARATION METHOD THEREOF

(71) Applicant: Zhejiang University, Hangzhou (CN)

(72) Inventors: Mi Yan, Hangzhou (CN); Chen Wu, Hangzhou (CN); Qiming Chen, Hangzhou (CN); Jiaying Jin, Hangzhou (CN); Yinzhu Jiang, Hangzhou (CN)

(21) Appl. No.: 17/683,716

(22) Filed: Mar. 1, 2022

(30) Foreign Application Priority Data
Dec. 27, 2021 (CN) 202111618066.3

(51) Int. Cl. C22C 38/34; C22C 38/52; C22C 38/46

(52) U.S. Cl. CPC C22C 38/34; C22C 38/52; C22C 38/46; C22C 2202/02

(57) ABSTRACT

A multicomponent FeCoSiM soft magnetic alloy is provided. M of the alloy is one or more of V, Cr and Ni. A sum of atomic percentages of alloy elements in the alloy is 100%. The atomic percents of the alloy elements meet the following conditions: Fe, 68˜78 at %; Co, 4˜12 at %; Si, 14˜18 at %; V, 0˜4 at %; Cr, 0˜4 at %; and Ni, 0˜4 at %. The preparation method of the alloy includes weighing raw materials according to the atomic percentages of the alloy elements and then performing melting and annealing heat treatment each in vacuum or a protective atmosphere. The alloy is obtained by a reasonable design of compositions and contents. A magnetocrystalline anisotropy constant of the alloy is low, a magnetostrictive coefficient of the alloy approaches zero and the alloy has characteristics of high saturation flux density and low coercivity.

### TECHNICAL FIELD

The disclosure relates to technical fields of soft magnetic materials, in particular to a multicomponent FeCoSiM soft magnetic alloy and a preparation method thereof.

### BACKGROUND

FeSi-based soft magnetic alloy is the largest and most widely used soft magnetic material at present. It is widely used in key fields such as power transmission, electronic devices, national defense and military industry. Saturation flux density and coercivity are key performance indexes of the soft magnetic alloy, which determine the conversion efficiency and power loss of the soft magnetic material. In the FeSi-based soft magnetic alloys, the addition of silicon (Si) can effectively reduce the magnetostrictive coefficient and magnetocrystalline anisotropy constant of the soft magnetic alloy, and significantly improve the resistivity of the soft magnetic alloy. However, as a non-magnetic element, Si will greatly reduce the saturation magnetization of the soft magnetic alloy. The magnetic properties of the FeSi-based soft magnetic alloy can be further regulated by adding other alloy elements. At present, FeSiAl alloy is the most successful ternary system with magnetocrystalline anisotropy and saturated magnetostrictive coefficient approaching zero. However, due to the addition of large content of non-magnetic element Si and aluminium (Al), the optimization of the magnetic permeability and the coercivity of FeSiAl alloy is at the expense of sacrificing the saturation magnetization.

In order to improve the comprehensive soft magnetic properties of FeSi-based soft magnetic alloy, the disclosure designs the composition of the alloy in combination with the following two aspects: 1) adding magnetic elements such as cobalt (Co) to enhance the magnetic coupling and the saturation magnetization of the alloy; 2) adding transition metal elements or non-metallic elements to make the saturated magnetostriction coefficient)Ls and the magnetocrystalline anisotropy constant K1 approach zero at the same time to obtain less coercivity. The disclosure adjusts the saturation magnetization, magnetostriction and magnetocrystalline anisotropy of the alloy through the reasonable ratio of various magnetic and transition elements in FeSi-based alloy, and optimizes the preparation method of multicomponent FeSi-based soft magnetic alloy to improve the comprehensive soft magnetic properties of the alloy.

### SUMMARY

Objectives of the disclosure is to provide a composition of a multicomponent FeSi-based soft magnetic alloy and a preparation method of the multicomponent FeSi-based soft magnetic alloy. The multicomponent FeSi-based soft magnetic alloy has excellent comprehensive soft magnetic properties of high saturation magnetization and low coercivity.

In order to achieve the above objectives, the disclosure adopts the following technical schemes:

a multicomponent FeCoSiM soft magnetic alloy essentially consists of iron (Fe), Co, Si and a transition metal element M, the transition metal element M is one or more selected from the group consisting of vanadium (V), chromium (Cr) and nickel (Ni), percentages of respective components of the multicomponent FeCoSiM soft magnetic alloy meet the following conditions: Fe, 68˜78 atomic percent (at %); Co, 4˜12 at %; Si, 14˜18 at %; V, 0˜4 at %; Cr, 0˜4 at %; and Ni, 0˜4 at %.

A preparation method of the multicomponent FeCoSiM soft magnetic alloy includes: proportioning, melting and annealing, specifically, the proportioning includes selecting raw materials according to the components of the multicomponent FeCoSiM soft magnetic alloy to obtain selected raw materials, cleaning the selected raw materials to obtain cleaned raw materials, and weighing the cleaned raw materials according to the percentages of the components to obtain weighed raw materials; the melting includes performing arc melting or induction melting to the weighted raw materials in vacuum or a protective atmosphere to obtain alloy ingots; the annealing includes performing annealing heat treatment to the obtained alloy ingots in vacuum or another protective atmosphere (also referred to as another protective gas).

In an embodiment, in the proportioning, each of the raw materials is a metal with a purity no less than 99.9% or a nonmetallic material with a purity no less than 99.9%, and cleaning the selected raw materials includes placing the selected raw materials in absolute ethanol or acetone to remove oil stains and organic matters on surfaces of the selected raw materials by ultrasonic cleaning.

In an embodiment, in the melting, an air pressure of the vacuum is less than 5×10⁻³ pascals (Pa) or the protective atmosphere (also referred to as protective gas) is an argon gas or a nitrogen gas with a purity no less than 99.9 volume percent (vol %); electromagnetic stirring may be used in the melting and each of the alloy ingots is melted repeatedly for 4˜6 times to reduce component segregation.

In an embodiment, in the annealing, the annealing specifically includes: performing the annealing heat treatment to the alloy ingots at 700 Celsius degrees (° C.)˜900° C. for 1 hour (h)˜3 h and then cooling with a furnace; in the annealing, an air pressure of the vacuum is less than 5×10⁻³ Pa or the protective atmosphere is a mixture gas of an argon gas or a nitrogen gas with a purity no less than 99.9 vol % and a hydrogen gas of 5˜10 vol %.

The percentage of the Si of the multicomponent FeCoSiM soft magnetic alloy of the disclosure is 15˜18 at %. Compared with the traditional Fe-6.5wt % Si (12.5 at % Si) alloy, the magnetocrystalline anisotropy constant is lower and the magnetostrictive coefficient is negative, which is convenient for adding magnetic elements to adjust the magnetostrictive coefficient and magnetocrystalline anisotropy constant. Moreover, the introduction of the more Si element is conducive to improve the resistivity of the alloy and reduce the eddy current loss in high-frequency applications.

The percentage of the Co of the multicomponent FeCoSiM soft magnetic alloy of the disclosure is 4˜12 at %. The addition of the Co element improves the saturation magnetization of the alloy, reduces the magnetic dilution effect of Si, and adjusts the magnetostrictive coefficient and magnetocrystalline anisotropy constant of the alloy to a certain range. By further introducing the V, the Cr and the Ni elements and giving play to the synergistic effect of the Si, the Co and various transition metal elements in the alloy, not only the magnetostrictive coefficient and magnetocrystalline anisotropy constant of the alloy tend to be zero, but also the saturation magnetization of the alloy is maintained.

In combination with the above, the multicomponent FeCoSiM soft magnetic alloy of the disclosure has excellent comprehensive magnetic properties of high saturation magnetization and low coercivity.

### DETAILED DESCRIPTION OF THE EMBODIMENTS

### Embodiment 1

A multicomponent FeCoSiM soft magnetic alloy is provided. Percentages of respective components of the multicomponent FeCoSiM soft magnetic alloy respectively are: Fe, 76 at %; Si, 15 at %; Co, 6 at %; and V, 3 at %. The preparation method of the multicomponent FeCoSiM soft magnetic alloy includes the following steps:

1) proportioning: selecting Fe particles with a purity of 99.95%, Co particles with a purity of 99.95%, V particles with a purity of 99.95% and polycrystalline Si lumps with a purity of 99.999%, and weighing raw materials with a total amount of 60 grams (g) according to the above percentages of the respective components. Before the weighing the raw materials, putting the raw materials into the absolute ethanol for the ultrasonic cleaning for 5 minutes (min) and drying the raw materials after the ultrasonic cleaning.

2) melting alloy: using a vacuum arc melting furnace, vacuumizing to the air pressure less than 5×10⁻³ Pa and then injecting 0.05 megapascals (MPa) high-purity argon as a protective atmosphere (also referred to as protective gas), and obtaining a soft magnetic alloy with uniform compositions by single melting for 3 min and repeated remelting for 6 times.

3) annealing heat treatment: placing the soft magnetic alloy (also referred to as melted alloy) in a tubular furnace, injecting the high-purity argon as a protective atmosphere, and annealing at 900° C. for 1 h and then cooling with the tubular furnace.

A static hysteresis loop of the prepared alloy (the multicomponent FeCoSiM soft magnetic alloy) was measured. The saturation magnetization of the multicomponent FeCoSiM soft magnetic alloy is 171.0 emu per gram (emu/g) and the coercivity is 0.32 Oersted (Oe).

### Embodiment 2

A multicomponent FeCoSiM soft magnetic alloy is provided. Percentages of respective components of the multicomponent FeCoSiM soft magnetic alloy respectively are: Fe, 68 at %; Si, 18 at %; Co, 10 at %; and Cr, 4 at %. The preparation method of the multicomponent FeCoSiM soft magnetic alloy includes the following steps:

1) proportioning: selecting Fe particles with a purity of 99.95%, Co particles with a purity of 99.95%, Cr particles with a purity of 99.95% and polycrystalline Si lumps with a purity of 99.999%, and weighing raw materials with a total amount of 40 g according to the above percentages of the respective components. Before the weighing the raw materials, putting the raw materials into the absolute ethanol for the ultrasonic cleaning for 5 min and drying the raw materials after the ultrasonic cleaning.

2) melting alloy: using a vacuum induction melting furnace, vacuumizing to the air pressure less than 5×10⁻³ Pa, and obtaining a soft magnetic alloy with uniform compositions by single melting for 5 min and repeated remelting for 4 times.

3) annealing heat treatment: placing the soft magnetic alloy in a vacuum tubular furnace, vacuumizing to the air pressure less than 5×10⁻³ Pa, and annealing at 750° C. for 3 h and then cooling with the vacuum tubular furnace.

A static hysteresis loop of the multicomponent FeCoSiM soft magnetic alloy was measured. The saturation magnetization of the multicomponent FeCoSiM soft magnetic alloy is 163.5 emu/g and the coercivity is 0.25 Oe.

### Embodiment 3

A multicomponent FeCoSiM soft magnetic alloy is provided. Percentages of respective components of the multicomponent FeCoSiM soft magnetic alloy respectively are: Fe, 78 at %; Si, 15 at %; Co, 4 at %; and Ni, 3 at %. The preparation method of the multicomponent FeCoSiM soft magnetic alloy includes the following steps:

0.1) proportioning: selecting Fe particles with a purity of 99.95%, Co particles with a purity of 99.95%, Ni particles with a purity of 99.95% and polycrystalline Si lumps with a purity of 99.999%, and weighing raw materials with a total amount of 40 g according to the above percentages of the respective components. Before the weighing the raw materials, putting the raw materials into the absolute ethanol for the ultrasonic cleaning for 5 min and drying the raw materials after the ultrasonic cleaning.

2) melting alloy: using a vacuum arc melting furnace, vacuumizing to the air pressure less than 5×10⁻³ Pa and then injecting 0.05 MPa high-purity nitrogen gas as a protective gas, using the electromagnetic stirring in the melting, and obtaining a soft magnetic alloy with uniform compositions by single melting for 4 min and repeated remelting for 6 times.

3) annealing heat treatment: placing the soft magnetic alloy in a vacuum tubular furnace, vacuumizing to the air pressure less than 5×10⁻³ Pa, and annealing at 900° C. for 1 h and then cooling with the vacuum tubular furnace.

A static hysteresis loop of the multicomponent FeCoSiM soft magnetic alloy was measured. The saturation magnetization of the multicomponent FeCoSiM soft magnetic alloy is 175.0 emu/g and the coercivity is 0.30 Oe.

### Embodiment 4

A multicomponent FeCoSiM soft magnetic alloy is provided. Percentages of respective components of the multicomponent FeCoSiM soft magnetic alloy respectively are: Fe, 74 at %; Si, 17 at %; Co, 6 at %; Ni, 2 at %; and Cr, 1 at %. The preparation method of the multicomponent FeCoSiM soft magnetic alloy includes the following steps:

1) proportioning: selecting Fe particles with a purity of 99.95%, Co particles with a purity of 99.95%, Ni particles with a purity of 99.95%, Cr particles with a purity of 99.95% and polycrystalline Si lumps with a purity of 99.999%, and weighing raw materials with a total amount of 50 g according to the above percentages of the respective components. Before the weighing the raw materials, putting the raw materials into the absolute ethanol for the ultrasonic cleaning for 10 min and drying the raw materials after the ultrasonic cleaning.

2) melting alloy: using a vacuum arc melting furnace, vacuumizing to the air pressure less than 5×10⁻³ Pa and then injecting 0.06 MPa high-purity argon gas as a protective gas, using the electromagnetic stirring in the melting, and obtaining a soft magnetic alloy with uniform compositions by single melting for 5 min and repeated remelting for 5 times.

3) annealing heat treatment: placing the soft magnetic alloy in a vacuum tubular furnace, injecting high-purity argon gas as a protective gas, and annealing at 800° C. for 1.5 h and then cooling with the vacuum tubular furnace.

A static hysteresis loop of the multicomponent FeCoSiM soft magnetic alloy was measured. The saturation magnetization of the multicomponent FeCoSiM soft magnetic alloy is 166.5 emu/g and the coercivity is 0.35 Oe.

### Embodiment 5

A multicomponent FeCoSiM soft magnetic alloy is provided. Percentages of respective components of the multicomponent FeCoSiM soft magnetic alloy respectively are: Fe, 76 at %; Si, 18 at %; Co, 4 at %; Ni, 4 at %; and V, 2 at %. The preparation method of the multicomponent FeCoSiM soft magnetic alloy includes the following steps:

1) proportioning: selecting Fe particles with a purity of 99.95%, Co particles with a purity of 99.95%, Ni particles with a purity of 99.95%, V particles with a purity of 99.95% and polycrystalline Si lumps with a purity of 99.999%, and weighing raw materials with a total amount of 50 g according to the above percentages of the respective components. Before the weighing the raw materials, putting the raw materials into the absolute ethanol for the ultrasonic cleaning for 5 min and drying the raw materials after the ultrasonic cleaning.

2) melting alloy: using a vacuum arc melting furnace, vacuumizing to the air pressure less than 5×10⁻³ Pa and then injecting 0.05 MPa high-purity argon gas as a protective gas, using the electromagnetic stirring in the melting, and obtaining a soft magnetic alloy with uniform compositions by single melting for 5 min and repeated remelting for 4 times.

3) annealing heat treatment: placing the soft magnetic alloy in a vacuum tubular furnace, injecting a mixture gas of the argon gas and 10 vol % hydrogen gas as a protective gas, and annealing at 750° C. for 3 h and then cooling with the vacuum tubular furnace.

A static hysteresis loop of the multicomponent FeCoSiM soft magnetic alloy was measured. The saturation magnetization of the multicomponent FeCoSiM soft magnetic alloy is 168.0 emu/g and the coercivity is 0.28 Oe.

### Embodiment 6

A multicomponent FeCoSiM soft magnetic alloy is provided. Percentages of respective components of the multicomponent FeCoSiM soft magnetic alloy respectively are: Fe, 73 at %; Si, 16 at %; Co, 6 at %; Cr, 3 at %; and V, 2 at %. The preparation method of the multicomponent FeCoSiM soft magnetic alloy includes the following steps:

1) proportioning: selecting Fe particles with a purity of 99.95%, Co particles with a purity of 99.95%, Ni particles with a purity of 99.95%, V particles with a purity of 99.95% and polycrystalline Si lumps with a purity of 99.999%, and weighing raw materials with a total amount of 50 g according to the above percentages of the respective components. Before the weighing the raw materials, putting the raw materials into the absolute ethanol for the ultrasonic cleaning for 5 min and drying the raw materials after the ultrasonic cleaning.

2) melting alloy: using a vacuum arc melting furnace, vacuumizing to the air pressure less than 5×10⁻³ Pa and then injecting 0.05 MPa high-purity argon gas as a protective gas, using the electromagnetic stirring in the melting, and obtaining a soft magnetic alloy with uniform compositions by single melting for 5 min and repeated remelting for 4 times.

3) annealing heat treatment: placing the soft magnetic alloy in a vacuum tubular furnace, injecting high-purity argon gas as a protective gas, and annealing at 850° C. for 3 h and then cooling with the vacuum tubular furnace.

A static hysteresis loop of the multicomponent FeCoSiM soft magnetic alloy was measured. The saturation magnetization of the multicomponent FeCoSiM soft magnetic alloy is 168.0 emu/g and the coercivity is 0.36 Oe.

1. (canceled)

2. A preparation method of a multicomponent FeCoSiM soft magnetic alloy, comprising:
proportioning: selecting raw materials according to components of the multicomponent FeCoSiM soft magnetic alloy to obtain selected raw materials, cleaning the selected raw materials to obtain cleaned raw materials, and weighing the cleaned raw materials according to percentages of the components to obtain weighed raw materials, wherein the components of the multicomponent FeCoSiM soft magnetic alloy essentially consist of iron (Fe), cobalt (Co), silicon (Si) and a transition metal element M;
melting: performing arc melting or induction melting to the weighed raw materials in vacuum or a protective atmosphere to obtain alloy ingots; and
annealing: performing annealing heat treatment to the alloy ingots in vacuum or another protective atmosphere.

3. The preparation method of the multicomponent FeCoSiM soft magnetic alloy according to claim 2, wherein in the proportioning, each of the raw materials is a metal with a purity no less than 99.9% or a nonmetallic material with a purity no less than 99.9%.

4. The preparation method of the multicomponent FeCoSiM soft magnetic alloy according to claim 2, wherein the cleaning the selected raw materials comprises:
placing the selected raw materials in absolute ethanol or acetone to remove oil stains and organic matters on surfaces of the selected raw materials by an ultrasonic cleaning.

5. The preparation method of the multicomponent FeCoSiM soft magnetic alloy according to claim 2, wherein in the melting, an air pressure of the vacuum is less than 5×10⁻³ pascals (Pa), and the protective atmosphere is an argon gas or a nitrogen gas with a purity no less than 99.9 volume percent (vol %).

6. The preparation method of the multicomponent FeCoSiM soft magnetic alloy according to claim 2, wherein in the melting, an electromagnetic stirring is used and each of the alloy ingots is melted repeatedly for 4˜6 times to reduce component segregation.

7. The preparation method of the multicomponent FeCoSiM soft magnetic alloy according to claim 2, wherein the annealing comprises: performing the annealing heat treatment to the alloy ingots at 700 Celsius degrees (° C.)˜900° C. for 1 hour (h)˜3 h and then cooling with a furnace.

8. The preparation method of the multicomponent FeCoSiM soft magnetic alloy according to claim 2, wherein in the annealing, an air pressure of the vacuum is less than 5×10⁻³ Pa and the protective atmosphere is a mixture gas of an argon gas or a nitrogen gas with a purity no less than 99.9 vol % and a hydrogen gas of 5˜10 vol %.

9. The preparation method of the multicomponent FeCoSiM soft magnetic alloy according to claim 2, wherein the transition metal element M is one or more selected from the group consisting of vanadium (V), chromium (Cr) and nickel (Ni).

10. The preparation method of the multicomponent FeCoSiM soft magnetic alloy according to claim 9, wherein the percentages of respective components of the multicomponent FeCoSiM soft magnetic alloy meet the following conditions:
Fe, 68˜78 atomic percent (at %);
Co, 4˜12 at %;
Si, 14˜18 at %;
V, 0˜4 at %;
Cr, 0˜4 at %; and
